(19) United States
(12) Patent Application Publication
(10) Pub. No.: US 2014/0180963 A1
(43) Pub. Date: Jun. 26, 2014

(54) SYSTEM AND METHOD FOR SPEND ANALYSIS

(71) Applicants: ASHISH MOHAN JHA, MUMBAI (IN); ANURAG KALIYA, MUMBAI (IN)

(72) Inventors: ASHISH MOHAN JHA, MUMBAI (IN); ANURAG KALIYA, MUMBAI (IN)

(21) Appl. No.: 13/771,445

(22) Filed: Feb. 20, 2013

(30) Foreign Application Priority Data
Dec. 21, 2012 (IN) 3578/MUM/2012

(51) Int. Cl. G06Q 40/00

(52) U.S. Cl. CPC G06Q 40/00
USPC 705/36 R; 705/35

(57) ABSTRACT

A system for spend analysis by providing strategies for mining spend information that analyzes classified spend data based on pre-determined strategies to find saving and compliance opportunities across category and supplier. These strategies are supplier payment based saving and compliance strategies, e.g., payment term rationalization and supplier payment term compliance. The system includes: a processor unit; and a computer readable medium storing instructions executable by the processor unit comprising: an input system adapted for entering pre-defined parameters; a strategy selection system to select a spend analysis strategy from a spend analysis strategy system; a category/supplier display system to display categories/suppliers for user-defined spend data that match the default/user-defined business constraints; wherein the category/supplier display system is integrated with a classification system adapted for classifying spend data based on pre-defined parameters; and an output system adapted for displaying output for a strategy being selected for a specific parameter.

### CROSS-REFERENCE TO RELATED APPLICATION

The instant application claims priority to Indian Patent Application Serial No. 3578/MUM/2012, filed Dec. 21, 2012, pending, the entire specification of which is expressly incorporated herein by reference.

### FIELD OF THE INVENTION

The present invention relates generally to electronic procurement and more particularly to procurement performance analysis including a system and method for spend analysis by providing strategies for mining spend information.

### BACKGROUND OF THE INVENTION

Procurement professionals always look for an opportunity to save money as well as to achieve compliance while purchasing goods/services. Most of the time, this saving and compliance opportunity lies within their organization and can be identified from their spend data. Major challenges in finding this opportunity are the huge volume of spend data and unavailability of standard strategy across organization.

Accordingly, there exists a need for new and improved procurement analysis systems and methods for spend analysis that overcomes at least one of the aforementioned problems.

### SUMMARY OF THE INVENTION

In accordance with the general teachings of the present invention, a system and method is provided for spend analysis by providing strategies for mining spend information. The present invention is based on standard category and supplier based saving strategies. It further creates business constraints for data analysis. It also helps in compliance based strategies.

An object of the present invention is to provide a system and method for spend analysis by providing strategies for mining spend information.

Another object of the present invention is to provide a system and method for analyzing classified spend data based on pre-determined strategies to find a saving and compliance opportunity across category and supplier.

Yet another object of the present invention is to provide a system and method for analyzing classified spend data based on pre-determined saving and compliance strategies in relation to payment terms of the supplier.

The present invention introduces a system for spend analysis by providing strategies for mining spend information.

The system includes:

a processor unit; and

a computer readable medium storing instructions executable by the processor unit comprising:

an input system adapted for entering pre-defined parameters, including but not limited to information of spend data, category of spend data, information of supplier, payment term, type of contract, contract term, other parameters and business constraints, and combinations thereof;

a strategy selection system to select a spend analysis strategy from a spend analysis strategy system, adapted for analyzing classified spend data based on pre-determined savings and compliance strategies;

a category/supplier display system to display categories/suppliers for user-defined spend data that match the default/user-defined business constraints;

wherein the category/supplier display system is integrated with a classification system adapted for classifying spend data based on pre-defined parameters; and

an output system adapted for displaying output for a strategy selected for a specific parameter.

The present system analyzes classified spend data based on pre-determined strategies to find out a saving and compliance opportunity across category and supplier.

The present invention is based on standard category and supplier based saving strategies. It further creates business constraints for data analysis. It also helps in compliance based strategies.

These strategies are supplier payment based saving and compliance strategies, e.g., payment term rationalization and supplier payment term compliance.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a screen capture of a display of a strategy selection system to select a payment term rationalization (“PTR”) strategy;

FIG. 2 illustrates a screen capture of a display of categories for user-defined spend data that match the default/user-defined business constraints;

FIG. 3 illustrates a screen capture of a display of an output report for a payment term rationalization strategy;

FIG. 4 illustrates a screen capture of a display of a strategy selection system to select a supplier payment term compliance (“SPTC”) strategy;

FIG. 5 illustrates a screen capture of a display of an output report for a supplier payment term compliance strategy;

FIG. 6 illustrates a schematic showing potential savings for a supplier payment term compliance strategy system for a scenario when a discount is availed;

FIG. 7 illustrates a schematic showing potential savings for a supplier payment term compliance strategy system when a discount is availed at different discount %;

FIG. 8 illustrates a schematic showing potential savings for a supplier payment term compliance strategy system when a discount is not availed; and

FIG. 9 illustrates a schematic, showing potential savings for a supplier payment term compliance strategy system when discount is not availed at different discount %.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

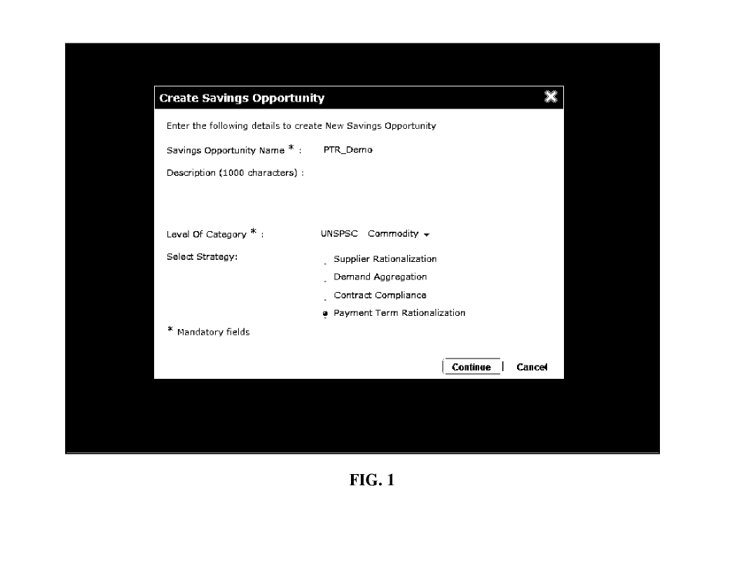

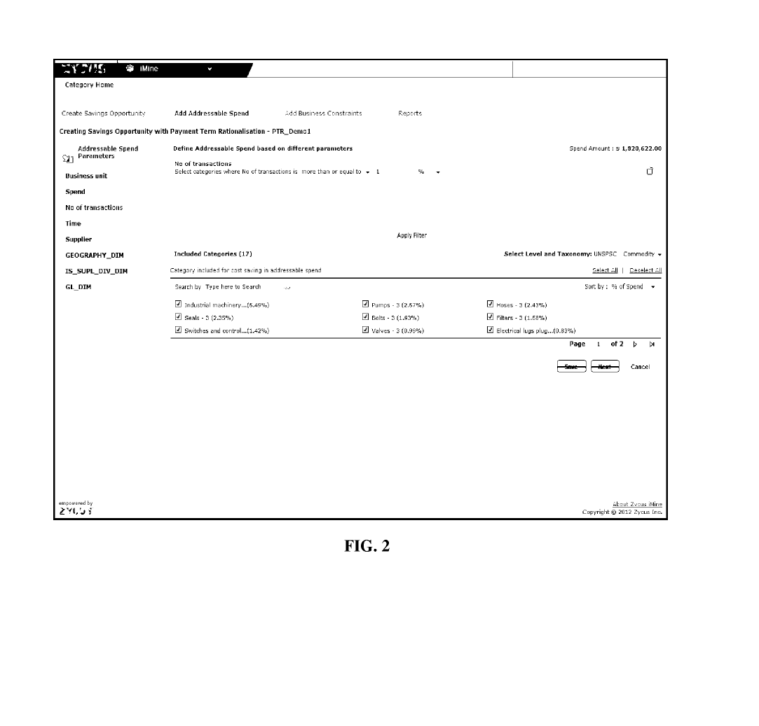

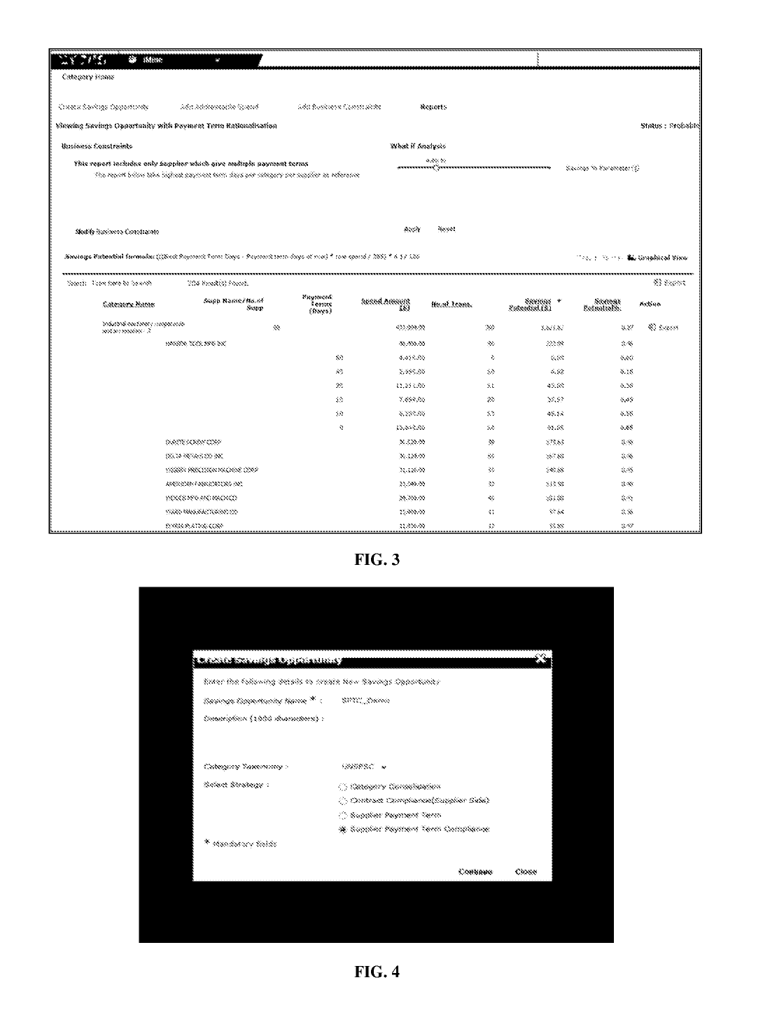

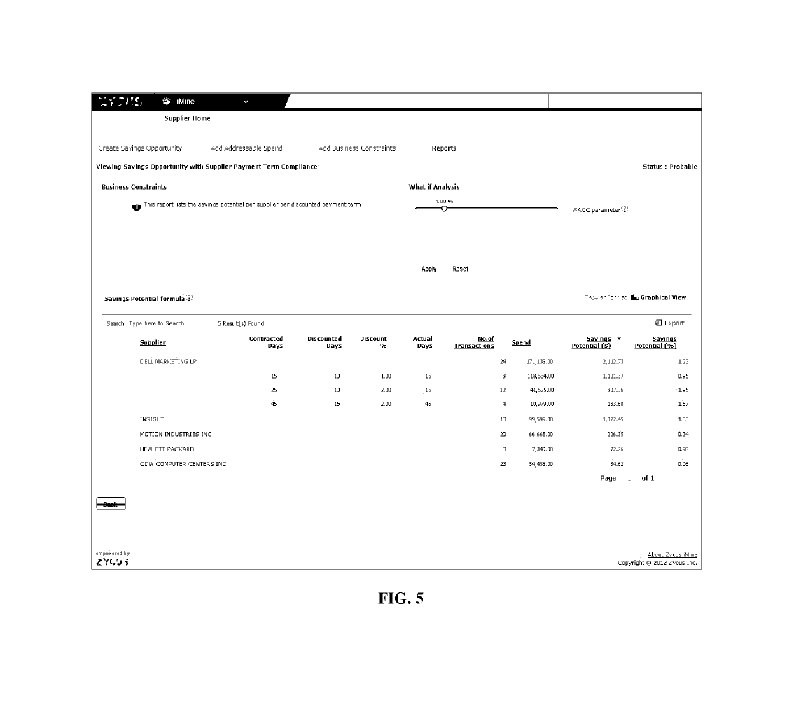

Referring to FIGS. 1-5, and according to an exemplary embodiment, a system is described for spend analysis by providing strategies for mining spend information, the system comprising:

a processor unit; and

a computer readable medium storing instructions executable by the processor unit comprising:

an input system adapted for entering pre-defined parameters, including but not limited to information of spend data, category of spend data, information of supplier, payment term, type of contract, contract term, other parameters and business constraints;

a strategy selection system to select a spend analysis strategy from a spend analysis strategy system, adapted for analyzing classified spend data based on pre-determined savings and compliance strategies;

a category/supplier display system to display categories/suppliers for user-defined spend data that match the default/user-defined business constraints;

wherein the category/supplier display system is integrated with a classification system adapted for classifying spend data based on pre-defined parameters; and

an output system adapted for displaying output for a strategy selected for a specific parameter.

According to another exemplary embodiment, the spend analysis strategy system further comprises:

a payment term rationalization strategy system adapted for identifying savings by tracking the difference in payment terms for a commodity of a supplier;

a supplier payment term compliance strategy system adapted for identifying compliance with the supplier by comparing different payment terms with each other suggesting the best day of payment and thereby calculating potential savings for different payment terms.

According to yet another exemplary embodiment, the payment term rationalization strategy system is adapted for rationalizing the payment term days to the best payment term, when payment terms are different for a commodity of a supplier.

The payment term rationalization strategy system is further adapted for calculating savings potential for a category of commodity, e.g., matching the pre-defined business constraints, with different payment terms by the formula:

Savings Potential=(((best payment term days−payment term days of the row)*row spend/365)*saving % parameter).

Payment to suppliers is usually done based on the contracted timelines such as advance payment, on delivery payment, net 30 days, net 45 days, net 60 days, etc. Payment terms rationalization is a strategy that suggests use of uniform payment terms most beneficial to the organization across suppliers or spend categories. Payment terms, when rationalized effectively, can result in considerable gains. Consider the following case scenarios:

### Case 1—Multiple Payment Terms For Different Items With A Single Supplier

Suppose supplier X is supplying three items A, B and C. While the payment is made on net 30 days for items A and B, for item C the payment is done on net 45 days. Because the supplier is the same for all the items, there is a possible opportunity to negotiate for a net 45 days payment term for all the items. This 15 day delay in the payment will help to keep more capital in hand.

### Case 2—Multiple Payment Terms For Single Category With Different Suppliers

Suppose category item X is being supplied by three different suppliers A, B and C. While the payment is made on net 30 days to suppliers A and B, payment to supplier C is done on net 45 days. In this case, because supplier C supplies the same category items as the other two, there is possible opportunity to negotiate with suppliers A and B for a net 45 days payment term.

Savings in both case scenarios will come for the extra working capital available for 15 additional days. Savings is calculated using the above described formula.

According to still another exemplary embodiment, the supplier payment term compliance strategy system may be adapted for comparing actual paid days, contracted days, discounted days and % discount for a supplier of a commodity being selected and thereby calculating capital gain and discount, if a discount is availed for a commodity.

The supplier payment term compliance strategy system may be further adapted for calculating the savings potential, and thus best payment day, by taking into consideration the difference in actual paid days, contracted days and discounted days, by the following formula:

### Case 1: When A Discount Is Availed

A=capital gain interest until the last discounted period day+discount gain;

B=capital interest gain until the last contracted period day;

wherein the potential savings=difference between A and B; and

wherein the best payment day=day with the higher potential savings.

According to still another exemplary embodiment, the supplier payment term compliance strategy system may be adapted for comparing actual paid days and contracted days for a supplier of a commodity being selected and thereby calculating the capital gain, if a discount is not availed for a commodity.

The supplier payment term compliance strategy system may be further adapted for calculating the savings potential, and thus best payment day, by taking into consideration the difference in actual paid days and contracted days by following formula:

### Case 2: When A Discount Is Not Availed

C=discount amount gain−capital interest loss due to early payment;

D=capital interest gain until the last contracted period day;

wherein the potential savings=difference between C and D; and

wherein the best payment day=day with higher potential savings.

Thus the supplier payment term compliance strategy system may analyze the pros and cons of the utilization of the entire credit period or paying early by availing the discount.

The payment term rationalization strategy system and the supplier payment term compliance strategy system may also be adapted for application of the interest rate.

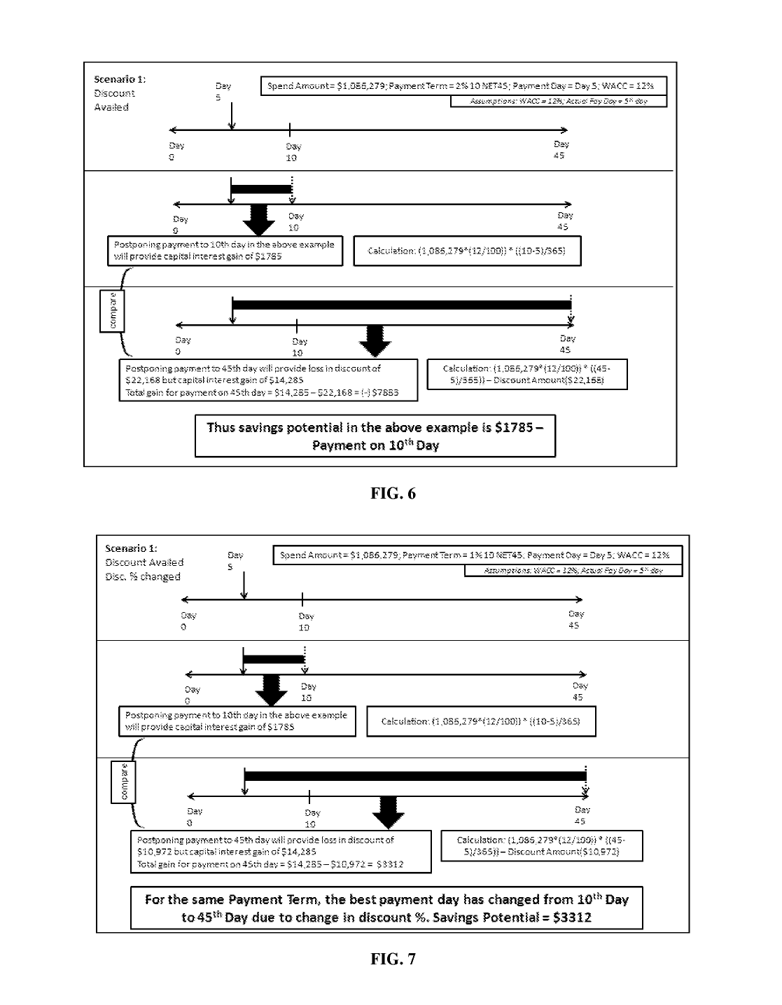

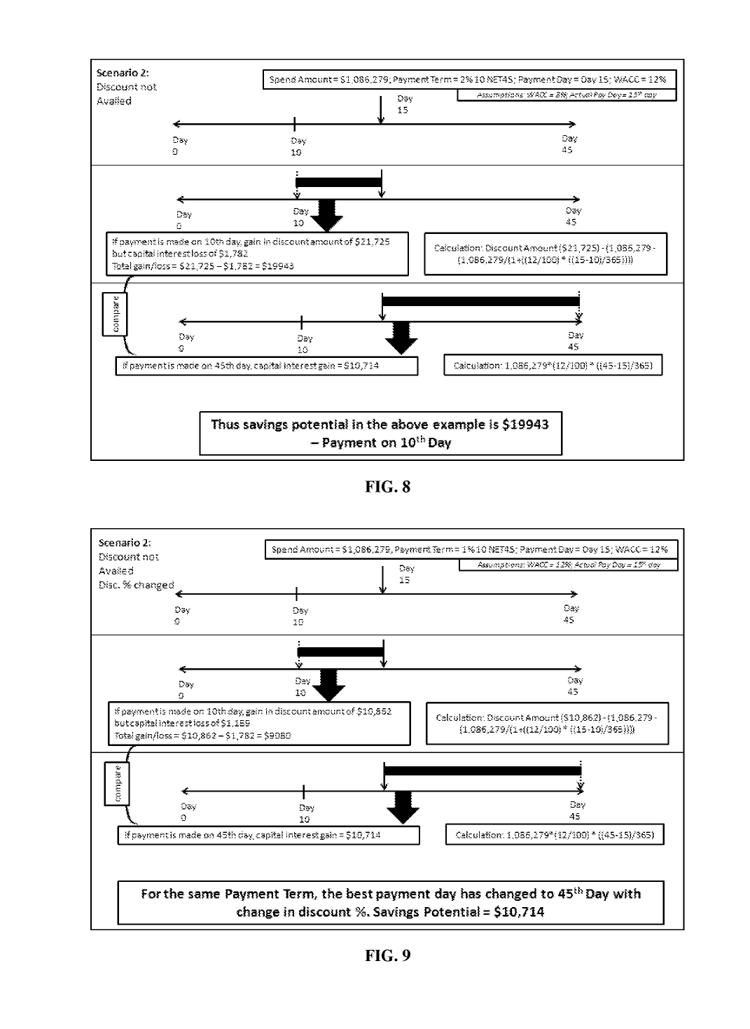

For example, consider these two situations: (1) if a discount is availed, i.e., payment is made within a discounted period; and (2) if discount is not availed, i.e., payment is not made within a discounted period. These two situations, e.g., at different discount scenarios and at discount percentages, are illustrated in FIGS. 6-9.

The benefits of the present invention include, without limitation, (1) it starts with actionable opportunities, not just static spend reports; (2) it simplifies the process of creating opportunity reports; and (3) it isolates and analyzes datasets with high savings potential that also gives compliance results.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A computer-implemented system for spend analysis by providing strategies for mining spend information, comprising:
a computer, comprising:
a processor unit; and
a computer readable medium storing instructions executable by the processor unit;
an input system operably associated with the computer and configured to enter pre-defined parameters selected from the group consisting of information of spend data, category of spend data, information of supplier, payment term, type of contract, contract term, business constraints, and combinations thereof;
a strategy selection system operably associated with the computer to select a spend analysis strategy from a spend analysis strategy system, configured to analyze classified spend data based on pre-determined savings and compliance strategies;
a category/supplier display system operably associated with the computer to display categories/suppliers for user-defined spend data that match the default/user-defined business constraints;
wherein the category/supplier display system is integrated with a classification system, configured to classify spend data based on pre-defined parameters;
an output system operably associated with the computer and configured to display output for a strategy being selected for a specific parameter;
a payment term rationalization strategy system operably associated with the computer and configured to identify savings by tracking a difference in payment terms for a commodity of a supplier; and
a supplier payment term compliance strategy system operably associated with the computer and configured to identify compliance with the supplier by comparing different payment terms with each other and suggesting the best day of payment, thereby calculating potential savings for different payment terms.

2. (canceled)

3. The system as claimed in claim 1, wherein, the payment term rationalization strategy system is configured to rationalize the payment term days to the best payment term, when payment terms are different for a commodity of a supplier.

4. The system as claimed in claim 1, wherein the payment term rationalization strategy system is configured to calculate potential savings for a category of commodity and match the pre-defined business constraints, with different payment terms according to the formula:
savings potential=(((best payment term days−payment term days)*spend amount/365)*saving % parameter).

5. The system as claimed in claim 1, wherein, the supplier payment term compliance strategy system is configured to compare actual paid days, contracted days, discounted days and % discount for a supplier of a commodity being selected and thereby calculating capital gain and discount, if a discount is availed for a commodity.

6. The system as claimed in claim 5, wherein, the supplier payment term compliance strategy system is configured to calculate the savings potential and thus best payment day by taking into consideration a difference in actual paid days, contracted days and discounted days, according to the following formula:
A=capital gain interest until the last discounted period day+discount gain;
B=capital interest gain until the last contracted period day;
wherein the potential savings=difference between A and B; and
wherein the best payment day=day with higher potential savings.

7. The system as claimed in claim 1, wherein, the supplier payment term compliance strategy system is configured to compare actual paid days and contracted days for a supplier of a commodity being selected and thereby calculating capital gain, if a discount is not availed for a commodity.

8. The system as claimed in claim 7, wherein the supplier payment term compliance strategy system is configured to calculate the savings potential and thus best payment day by taking into consideration a difference in actual paid days and contracted days, according to the following formula:
C=discount amount gain−capital interest loss due to early payment;
D=capital interest gain until the last contracted period day;
wherein the potential savings=difference between C and D; and
wherein the best payment day=day with higher potential savings.

9. The system as claimed in claim 1, wherein, the supplier payment term compliance strategy system is configured to apply an interest rate.

10. The system as claimed in claim 1, wherein the output system is configured to display an output in a report form containing potential savings for different payment terms of a supplier of a specific category, when the payment term rationalization strategy system is being selected.

11. The system as claimed in claim 1, wherein the output system is configured to display output in a report form containing potential savings by comparing payment on actual days, contracted days and discounted days across suppliers, when the supplier payment term compliance strategy system is being selected.

12. A computer-implemented method for spend analysis by providing strategies for mining spend information, comprising:
providing a computer, comprising:
a processor unit; and
a computer readable medium storing instructions executable by the processor unit to perform the steps of:
entering pre-defined parameters selected from the group consisting of information of spend data, category of spend data, information of supplier, payment term, type of contract, contract term, other parameters and business constraints, and combinations thereof;
selecting a spend analysis strategy from a spend analysis strategy system configured to analyze classified spend data based on pre-determined savings and compliance strategies;
providing a category/supplier display to display categories/suppliers for user-defined spend data that match the default user-defined business constraints;
wherein the category/supplier display is integrated with a classification system configured to classify spend data based on pre-defined parameters; and
displaying output for a strategy being selected for a specific parameter;
providing a payment term rationalization strategy system operably associated with the computer and configured to identify savings by tracking a difference in payment terms for a commodity of a supplier; and
providing a supplier payment term compliance strategy system operably associated with the computer and configured to identify compliance with the supplier by comparing different payment terms with each other and suggesting the best day of payment, thereby calculating potential savings for different payment terms.

13. (canceled)

14. The method as claimed in claim 12, wherein the payment term rationalization strategy system is configured to rationalize the payment term days to the best payment term, when payment terms are different for a commodity of a supplier.

15. The method as claimed in claim 12, wherein the payment term rationalization strategy system is configured to calculate savings potential for a category of commodity, matching the pre-defined business constraints, with different payment terms according to the formula:
Savings Potential=(((best payment term days−payment term days)*spend amount/365)*saving % parameter).

16. The method as claimed in claim 12, wherein the supplier payment term compliance strategy system is configured to compare actual paid days, contracted days, discounted days and % discount for a supplier of a commodity being selected and thereby calculating capital gain and discount, if a discount is availed for a commodity.

17. The method as claimed in claim 16, wherein the supplier payment term compliance strategy system is configured to calculate the savings potential and thus best payment day by taking into consideration difference in actual paid days and contracted days, according to the following formula:
C=discount amount gain—capital interest loss due to early payment;
D=capital interest gain until the last contracted period day;
wherein potential savings=difference between C and D; and
wherein best payment day=day with higher potential savings.

18. The method as claimed in claim 12, wherein the supplier payment term compliance strategy system is configured to compare actual paid days and contracted days for a supplier of a commodity being selected and thereby calculating capital gain, if a discount is not availed for a commodity.

19. The method as claimed in claim 18, wherein, the supplier payment term compliance strategy system is configured to calculate the savings potential and thus best payment day by taking into consideration difference in actual paid days and contracted days, according to the following formula:
C=discount amount gain−capital interest loss due to early payment;
D=capital interest gain until the last contracted period day;
wherein potential savings=difference between C and D; and
wherein best payment day=day with higher potential savings.

20. The method as claimed in claim 12, wherein the supplier payment term compliance strategy system is configured to apply an interest rate.

21. The method as claimed in claim 12, wherein for the payment term rationalization strategy system, further comprising displaying output configured to display output in a report form containing potential savings for different payment terms of a supplier of a specific category.

22. The method as claimed in claim 12, wherein, for the supplier payment term compliance strategy system, further comprising displaying output configured to display output in a report form containing potential savings by comparing payment on actual days, contracted days and discounted days across suppliers.
